(19) United States
(12) Patent Application Publication
(10) Pub. No.: US 2014/0351067 A1
(43) Pub. Date: Nov. 27, 2014

(54) System and Method for Increasing the Efficiency and Profitability of Deliveries from a Point-of-Sale Provider to a Retail Consumer

(71) Applicants: Jeff Tomcsik, Avenue, MD (US); Riaz Rayek, Chantilly, VA (US); Sanzar F. Kakar, Chantilly, VA (US)

(72) Inventors: Jeff Tomcsik, Avenue, MD (US); Riaz Rayek, Chantilly, VA (US); Sanzar F. Kakar, Chantilly, VA (US)

(21) Appl. No.: 14/282,289

(22) Filed: May 20, 2014

Related U.S. Application Data
(60) Provisional application No. 61/825,919, filed on May 21, 2013.

(51) Int. Cl. G06Q 50/12; G06Q 20/20

(52) U.S. Cl. CPC G06Q 50/12; G06Q 20/202
USPC 705/15; 705/21

(57) ABSTRACT

A system and method for increasing the efficiency and profitability of delivery services between a point-of-sale provider for services or delivered goods, such as comestibles and a retail consumer.

### PRIORITY CLAIMS AND REFERENCE RELATED APPLICATIONS

This application claims priority to related and commonly owned U.S. provisional patent application No. 61/825,919, filed May 21, 2013, the entire disclosure of which is incorporated herein by reference.

### BACKGROUND OF THE INVENTION

1. Field of the Invention

The present invention relates to methods for managing delivery of goods such as comestibles and services.

2. Discussion of the Prior Art

Retail sellers of goods such as restaurants (e.g., pizza parlors) that generate substantial business from delivery services are often very inefficient. They take a call from a home or business within their delivery range, process the order and send a delivery vehicle in route to destination regardless of how many delivery orders are made and on board. They also typically disregard the direction from source to point of delivery. In other words, a delivery vehicle may have three orders on board that are in three different directions. The same can be said for other areas of retail that generate a substantial business from delivery services.

This model costs the company valuable human resources, time, and ties up those resources from effectively delivering the next order if not made before the original delivery process starts, potentially costing the company more resources in anticipation of orders that may not be actualized.

There is a need, therefore, for a convenient, flexible, inexpensive and unobtrusive system and method for increasing the profitability of deliveries from a point-of-sale provider to a retail consumer.

### OBJECTS AND SUMMARY OF THE INVENTION

Accordingly, it is an object of the present invention to overcome the above mentioned difficulties by providing a convenient, flexible, inexpensive and efficient system and method for point-of-sale providers to increase the profitability of deliveries from a point-of-sale provider to a retail consumer.

In accordance with the present invention, a point-of-sale provider or retail seller of goods such as a restaurant (e.g., pizza parlor) operator has a system and method for increasing the profitability of a delivery from that point-of-sale provider to a retail consumer, comprising:

(a) placing an initial order with the point-of-sale provider by the retail (initial order) consumer where that consumer is identified by a unique telephone number for that consumer;

(b) providing a point-of-sales system with software for that point-of-sale provider with at least Internet access or a database of contact information for previous point-of-sale provider consumers wherein that contact information includes unique corresponding addresses for each unique consumer telephone number;

(c) executing an algorithm on said software wherein said algorithm provides:
(i) one or more additional unique addresses located between a location for said point-of-sale provider and a location for said consumer wherein said additional unique addresses correspond with a pre-determined deviation path wherein said deviation path provides an acceptable delivery time for said initial order consumer;
(ii) a listing of previous point-of-sale provider consumers wherein said previous consumers have an address corresponding with said deviation path and have provided a method of contact wherein said method includes at least a cell phone number;
(iii) a directory of previous point-of-sale provider consumers wherein said consumers are auction subscribers, have an address corresponding with said deviation path and have provided a method of contact wherein said method includes at least a cell phone number;
(iv) delivery of an “Alert” message to each said consumer found on said listing by said method of contact wherein said Alert message is customized according to said consumer's order history and said message is valid for a specified period of time;
(v) delivery of an Alert message to each said subscriber found on said directory by said method of contact wherein said message informs said consumer they are on said deviation path (or “Pizza Path”);

(d) providing a downloadable application for said point-of-sale provider's consumers;

(e) enabling said auction subscribers to view a catalog of at least one product available from said point-of-sale provider at an initial purchase price wherein said price will reduce by a specified value at specified intervals of time live via said application;

(f) enabling said auction subscribers to purchase said product from said point-of-sale provider via said application;

(g) providing said initial consumer with an incentive to use the application, place said order with said point-of-sale provider and accept that said delivery will be made via said deviation path; and

(h) enabling said initial consumer to view said incentive live as said delivery is in progress.

The above and still further objects, features and advantages of the present invention will become apparent upon consideration of the following detailed description of a specific embodiment thereof, particularly when taken in conjunction with the accompanying drawings, wherein like reference numerals in the various figures are utilized to designate like components.

### DESCRIPTION OF THE DRAWINGS

FIG. 1 illustrates a system and method for communicating between a point-of-sale provider and a retail consumer using the provider's point-of-sale software, in accordance with the present invention.

FIG. 2 illustrates a system and method for communicating between a point-of-sale provider, a retail consumer, and previous retail consumers using the provider's point-of-sale software, in accordance with the present invention.

FIG. 3 illustrates a system and method for communicating between a point-of-sale provider, an initial retail consumer, previous point-of-sale provider retail consumers 340, and auction subscribers using the provider's point-of-sale software, in accordance with the present invention.

FIG. 4 illustrates a system and method for determining addresses for previous retail consumers located between a location for the point-of-sale provider and a location for the retail consumer where the addresses correspond with a pre-determined deviation path and where the deviation path provides an acceptable delivery time for the retail consumer using the provider's point-of-sale software, in accordance with the present invention.

FIG. 5 illustrates a system and method using the provider's point-of-sale software for delivering a message to each retail consumer found amongst the addresses located between a location for the point-of-sale provider and the location for the retail consumer and the retail consumers who accept the offer in the message, in accordance with the present invention.

FIG. 6A illustrates a system and method using the provider's point-of-sale software for determining a directory of point-of-sale provider retail consumers where the retail consumers are auction subscribers, who have an address located between a location for the point-of-sale provider and the location for the retail consumer, the address corresponds with a pre-determined deviation path and the auction subscribers have provided a method of contact where the method includes at least a cell phone number. The auction subscribers are notified of the product availability and their respective prices initially, in accordance with the present invention.

FIG. 6B illustrates a system and method using the provider's point-of-sale software for auction subscribers to be notified of product availability and their respective prices after a minute has elapsed, in accordance with the present invention.

FIG. 6C illustrates a system and method using the provider's point-of-sale software for auction subscribers to be notified of product availability and their respective prices after four minutes have elapsed and an auction subscriber has purchased a product, in accordance with the present invention.

FIG. 6D illustrates a system and method using the provider's point-of-sale software for auction subscribers to be notified of product availability and their respective prices after seven minutes have elapsed and auction subscribers have a product, in accordance with the present invention.

FIG. 7 illustrates a system and method using the provider's point-of-sale software for communicating between a point-of-sale provider's system and retail consumer devices with the software and retail consumer devices without the software, in accordance with the present invention.

FIG. 8 illustrates a system and method using the provider's point-of-sale software to calculate a deviation path between the location of the point-of-sale provider and the location of the initial retail consumer and determine the addresses of previous retail consumers with a location on the deviation path, in accordance with the present invention.

FIG. 9A-9B illustrates a method using the provider's point-of-sale software to increase the profitability of a delivery from a point-of-sale provider to an initial retail consumer, in accordance with the present invention.

### DESCRIPTION OF THE PREFERRED EMBODIMENT

The attached appendices disclose a specific, illustrative embodiment for the point-of-sale provider to a retail consumer delivery method of the present invention.

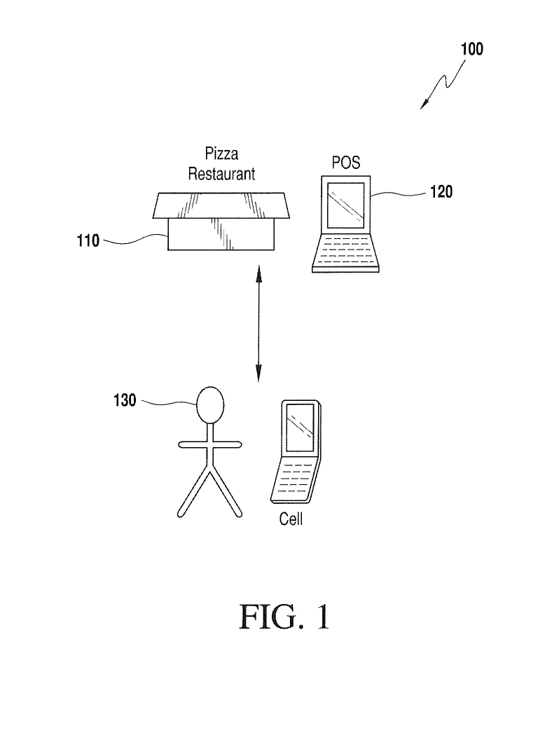

FIG. 1 illustrates a system 100 and method for communicating between a point-of-sale provider 110 and an initial retail consumer 130 using the provider's point-of-sale software 120, in accordance with the present invention.

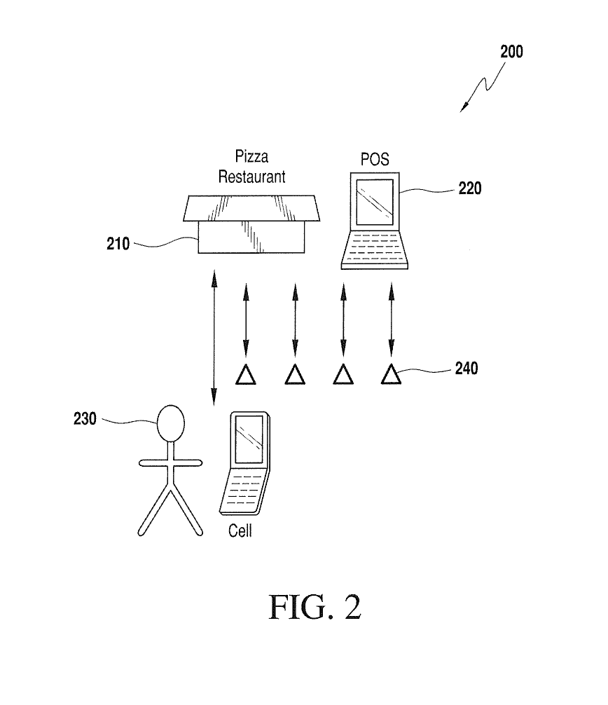

FIG. 2 illustrates a system 200 and method for communicating between a point-of-sale provider 210, an initial retail consumer 230, and previous retail consumers 240 using the provider's point-of-sale software 220, in accordance with the present invention.

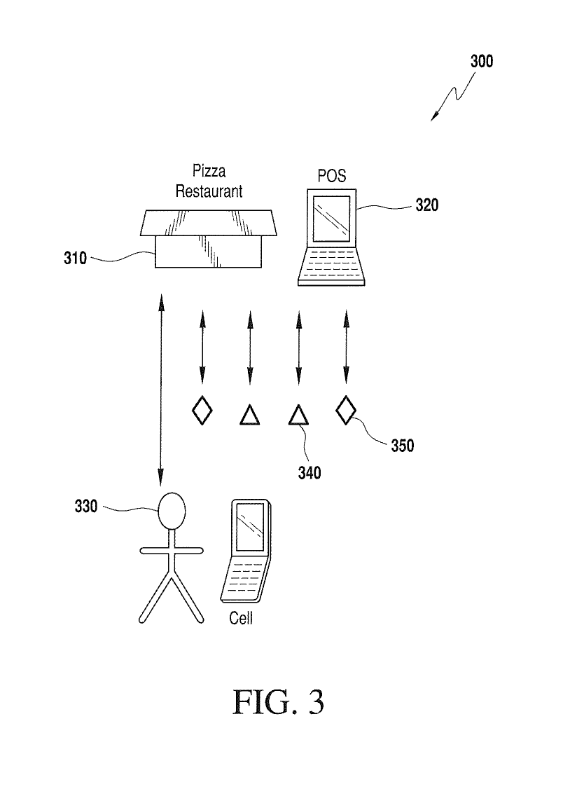

FIG. 3 illustrates a system and method for communicating between a point-of-sale provider 310, an initial retail consumer 330, previous point-of-sale provider retail consumers 340, and auction subscribers 350 using the provider's point-of-sale software 320, in accordance with the present invention.

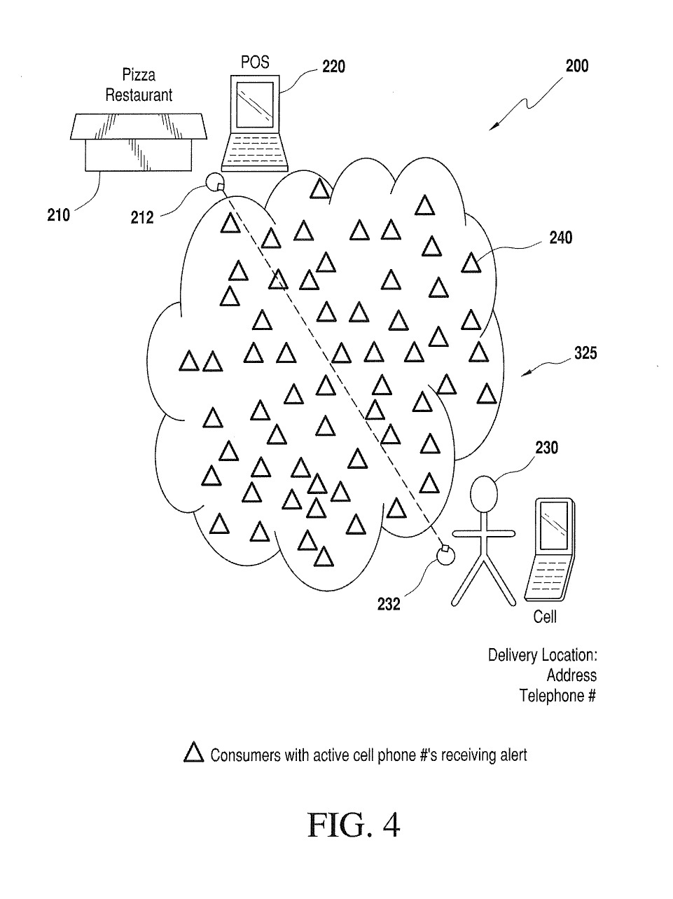

FIG. 4 illustrates a system 200 and method for determining addresses for previous retail consumers 240 located between a location for the point-of-sale provider 212 and a location for an initial retail consumer 232 where the addresses correspond with a pre-determined deviation path and where the deviation path provides an acceptable delivery time for the initial retail consumer using the provider's point-of-sale software 220, in accordance with the present invention.

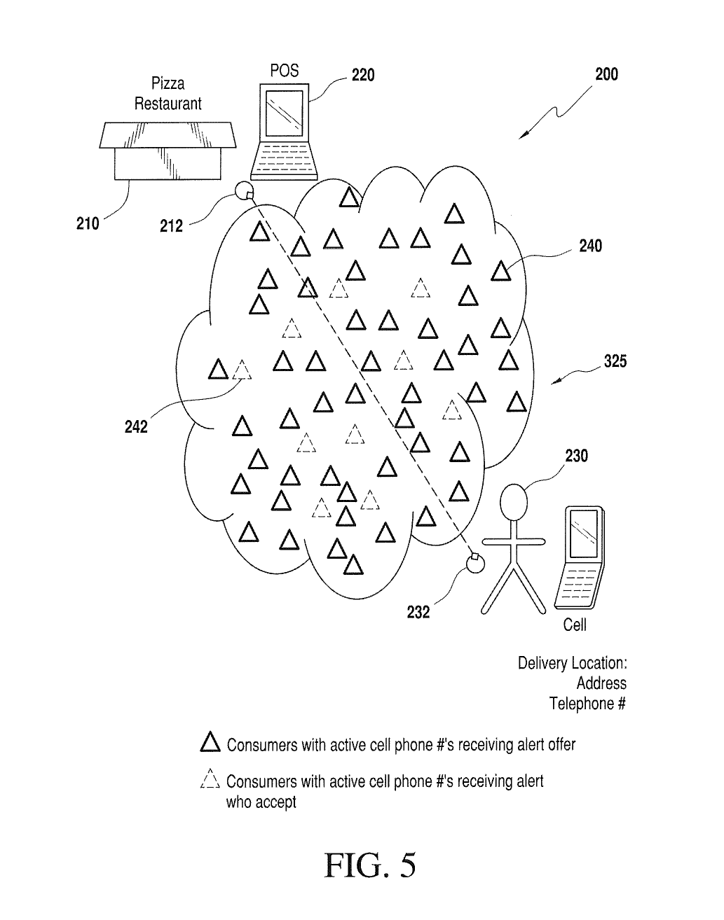

FIG. 5 illustrates a system 200 and method using the provider's point-of-sale software 220 for delivering a message to each previous retail consumer 240 found amongst the addresses located between a location for the point-of-sale provider 212 and the location for the initial retail consumer 232 and the location for previous retail consumers who accept the offer 242 in the message, in accordance with the present invention.

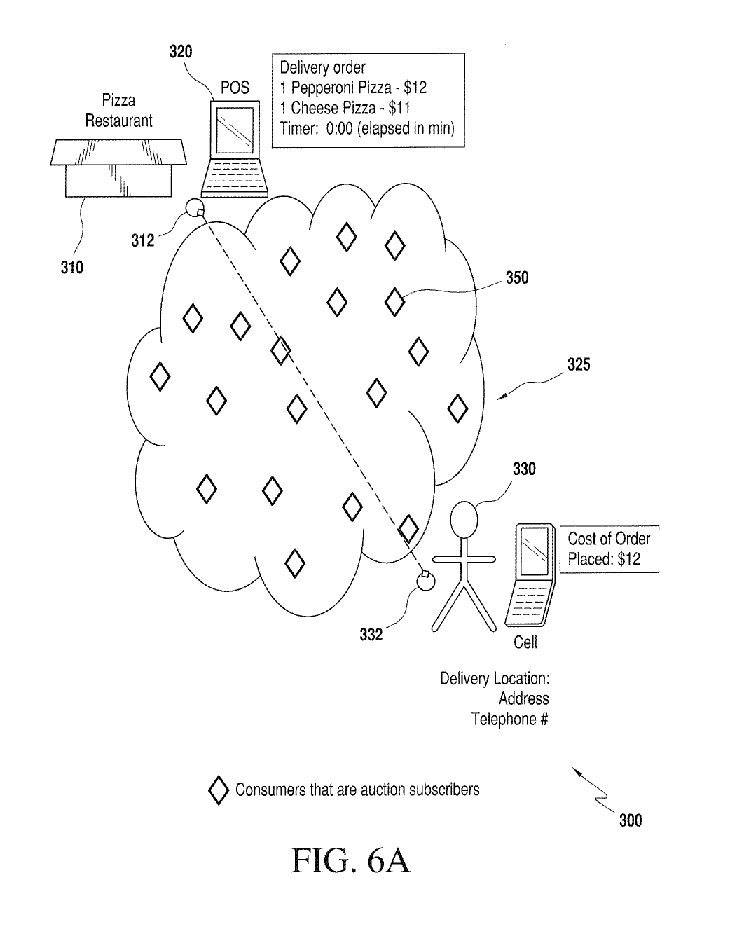

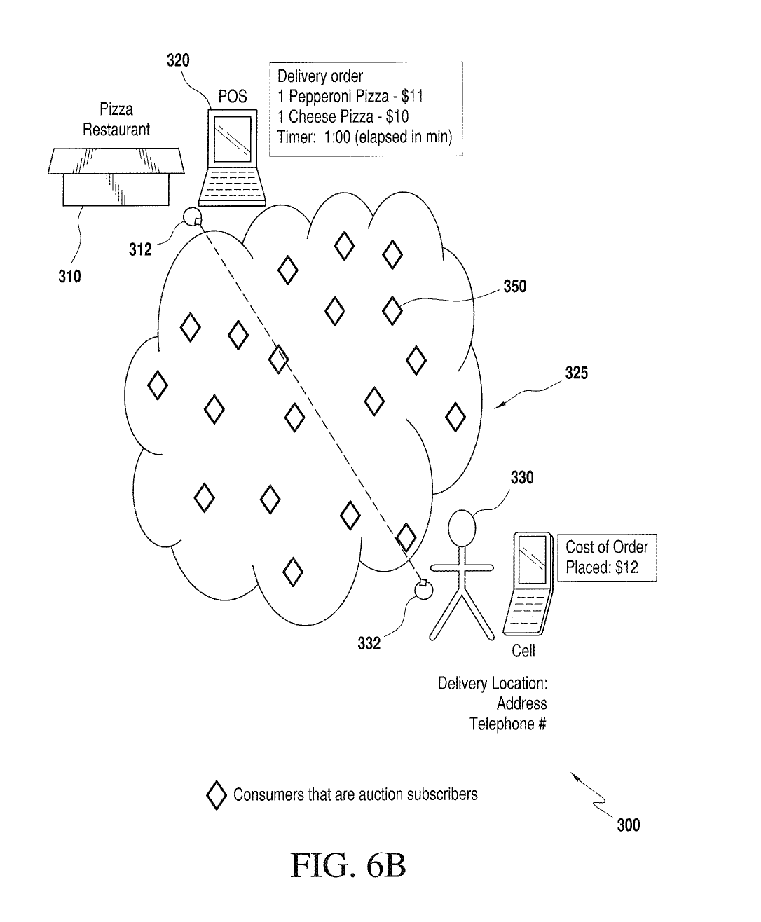

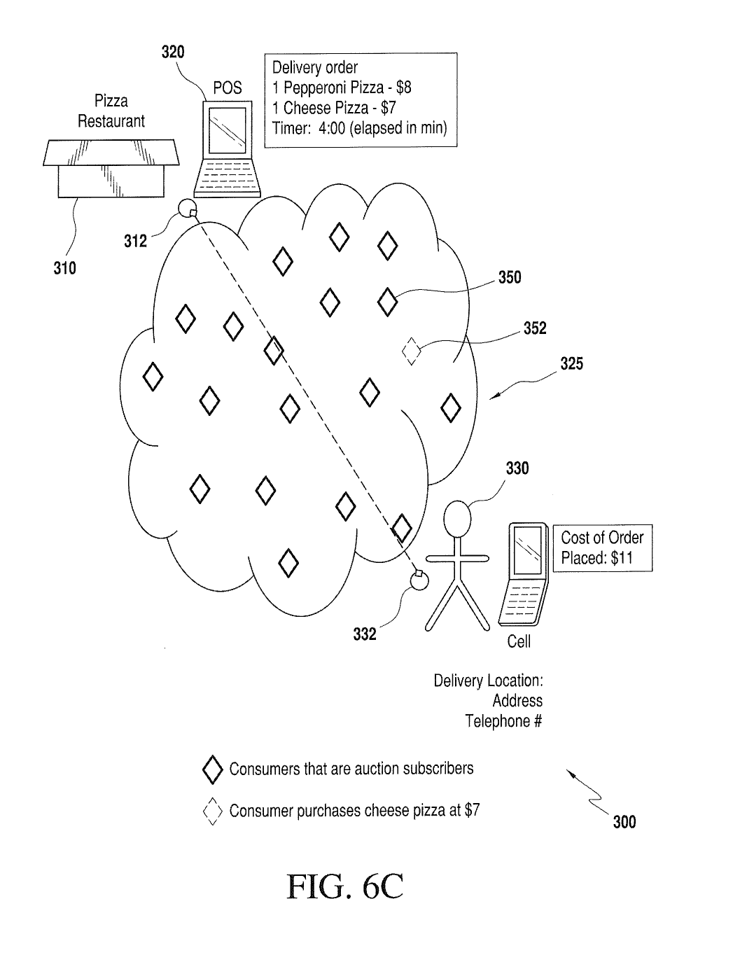

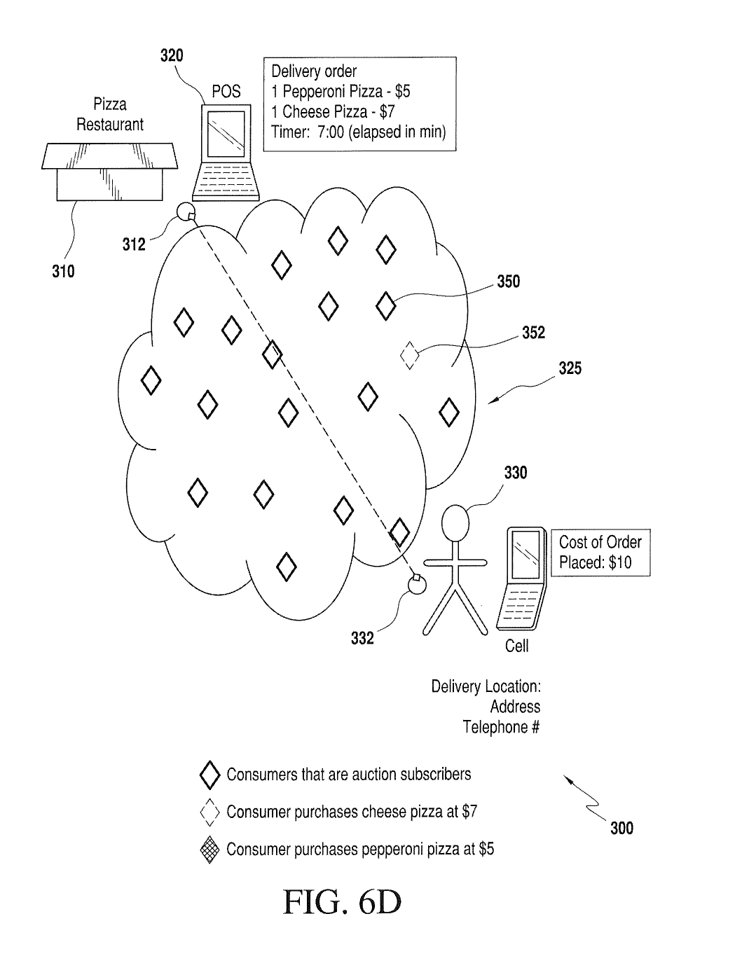

FIG. 6A illustrates a system 300 and method using the provider's point-of-sale software 320 for determining a directory of previous point-of-sale provider retail consumers where the retail consumers are auction subscribers 350, have an address located between a location for the point-of-sale provider 312 and the location for the initial retail consumer 332, the address corresponds with a pre-determined deviation path 325 and the auction subscribers 350 have provided a method of contact where the method includes at least a cell phone number. The auction subscribers 350 are notified of the product availability and their respective prices initially, in accordance with the present invention. Auction subscribers may be previous point-of-sale provider retail consumers but can also be new point-of-sale provider retail consumers.

FIG. 6B illustrates a system 300 and method using the provider's point-of-sale software 320 for auction subscribers 350 to be notified of product availability and their respective prices after a minute has elapsed, in accordance with the present invention.

FIG. 6C illustrates a system and method using the provider's point-of-sale software 320 for auction subscribers 350 to be notified of product availability and their respective prices after four minutes have elapsed and an auction subscriber 350 has purchased a product 352, in accordance with the present invention. The total cost for the order placed by initial retail consumer 330 decreases by a pre-defined amount as an incentive for the initial retail consumer 330 to use the Free Lunch software.

FIG. 6D illustrates a system 300 and method using the provider's point-of-sale software 320 for auction subscribers to be notified of product availability and their respective prices after seven minutes have elapsed and auction subscribers 350 have a product 352, in accordance with the present invention. The total cost for the order placed by initial retail consumer 330 decreases by a pre-defined amount as an incentive for the initial retail consumer 330 to use the Free Lunch software.

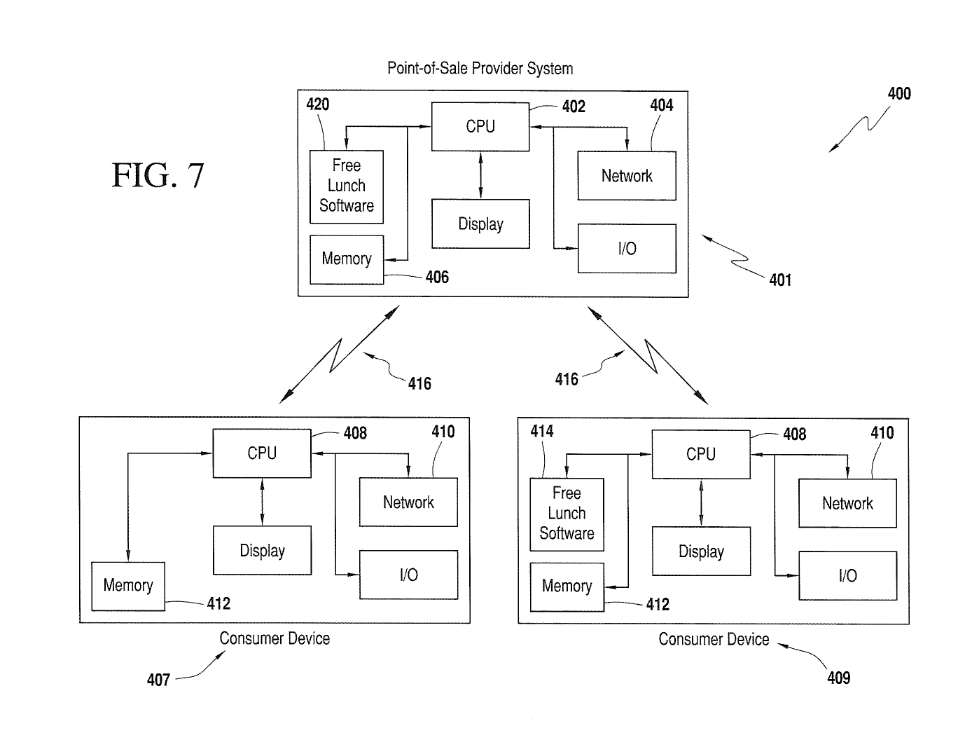

FIG. 7 illustrates a system 400 and method using the provider's point-of-sale software 420 for communicating between a point-of-sale provider's system 401 and retail consumer devices with the software 409 and retail consumer devices without the software 407, in accordance with the present invention.

A point-of-sale provider's system 401 will typically be a device which has a processor 402, network capabilities to connect to the Internet 404, a display, the minimum input/output devices required to operate the device, computer memory, such as random-access memory (RAM) for system operation and data storage 406 including a database of previous point-of-sale provider retail consumer information, and the Free Lunch software algorithm 414.

Retail consumer devices 407 409 is a user-provided personal electronic device such as a cell phone or smartphone with a processor 408, memory 412, and wireless network capabilities 410.

Computer memory for a point-of-sale provider's system 406 and retail consumer devices 412 can be any type of computer memory or any other type of electronic storage medium that is located either internally or externally to the respective element, such as, for example, read-only memory (ROM), a computer-readable medium, or the like. According to exemplary embodiments, the respective RAM and/or ROM can contain, for example, the operating program for any of the foregoing components can be stored in RAM and/or ROM and can, for example, be programmed using conventional techniques known to those having ordinary skill in the art of computer programming. The point-of-sale provider's system may have a wired or wireless connection. For purposes of nomenclature, wired includes but is not limited to Modem, Ethernet, Cable, DSL, and/or Fibre Optics.

Retail consumers devices 407 409 will have network capabilities to connect wirelessly 416 with the point-of-sale provider. Some previous point-of-sale provider retail consumer and auction subscriber devices 409, and the initial retail consumer will have an electronic device 409 with the Free Lunch software algorithm 414 installed.

All of the connections depicted in FIG. 7 and described above may be wireless connections using the most current technology, such as, for example, a wireless cellular or internet connection or a Wi-Fi 802.11 protocol connection. For purposes of nomenclature, wirelessly includes but is not limited to Bluetooth™, Wi-Fi, 802.11, 3G, and 4G.

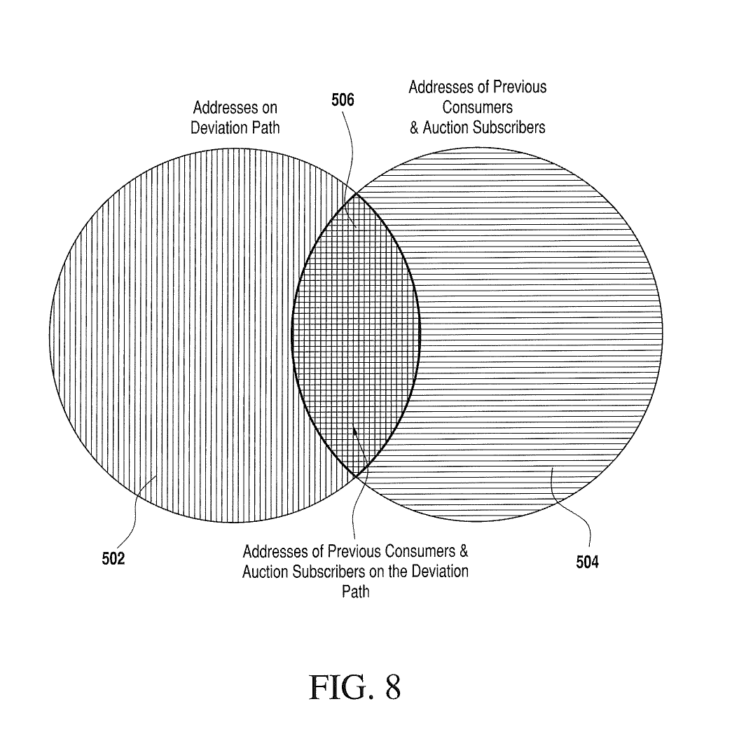

FIG. 8 illustrates a system and method using the provider's point-of-sale software to calculate a deviation path 325 between the location of the point-of-sale provider 312 and the location of the initial retail consumer 332 and determine the addresses of previous point-of-sale provider retail consumers and auction subscribers 504 with a location on the deviation path 506 from the addresses found on the deviation path 502, in accordance with the present invention. The provider's point-of-sale software 420 searches the memory 406 of the point-of-sale provider system, where the database of previous point-of-sale provider retail consumer information is stored, to analyze the addresses for previous point-of-sale provider retail consumers to determine if the respective retail consumer is located on the deviation path. The information stored for each previous point-of-sale provider retail consumer information includes at least an address but stores other information such as but not limited to phone numbers, previous order history, consumer preferences and other contact information.

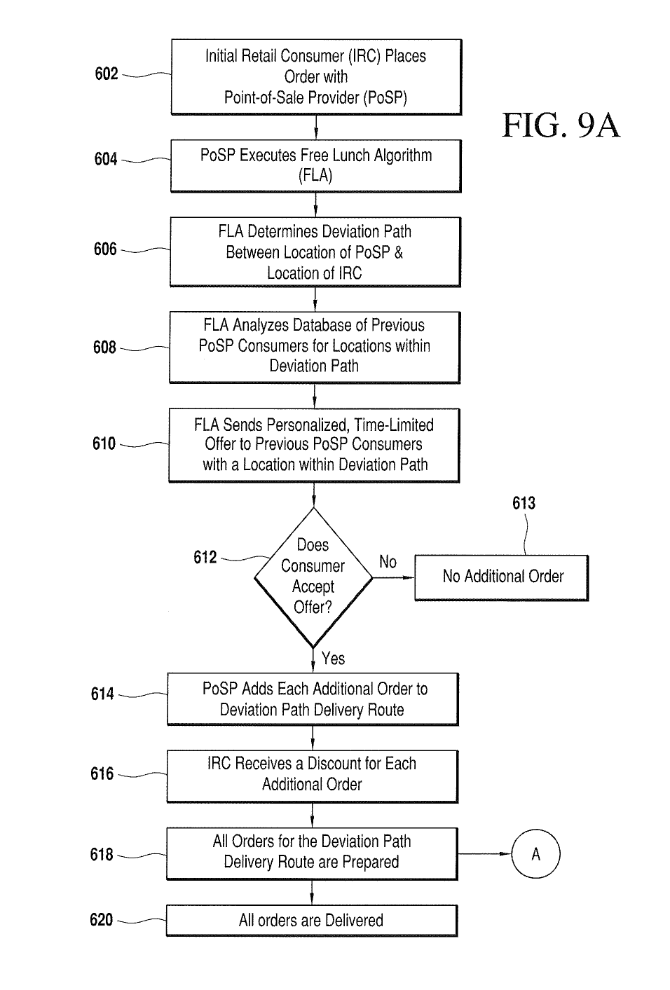

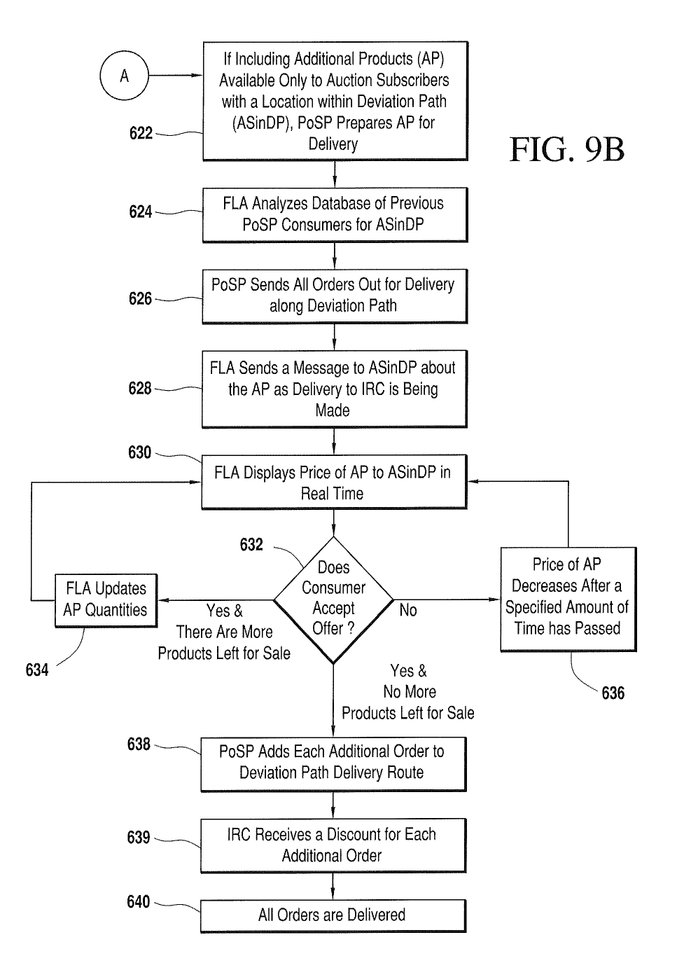

FIG. 9A-9B illustrates a method using the provider's point-of-sale software to increase the profitability of a delivery from a point-of-sale provider to an initial retail consumer, in accordance with the present invention. An initial retail consumer places an initial order with the point-of-sale provider via the Free Lunch algorithm 602. The initial retail consumer does not have to place the initial order via the Free Lunch algorithm but may use any form of communication with the point-of-sale provider, such as but not limited to a call-in order or web order. The point-of-sale provider executes the algorithm on their system 604 to determine the deviation path between the location for the point-of-sale provider and the location for the initial retail consumer 606. The Free Lunch algorithm then analyzes the database of previous point-of-sale provider retail consumer information to determine which previous point-of-sale provider retail consumers are located within the deviation path 608. The algorithm then sends a personalized, time-limited offer to those previous point-of-sale provider retail consumers 240 on the deviation path 610, where the personalization of the offer is based on the previous point-of-sale provider retail consumer's past order history stored in the database. The retail consumer 240 has the choice to either accept, reject, or ignore the offer 612. If the previous point-of-sale provider retail consumer 240 does not accept the offer before the time limit expires, then no additional order is added to the delivery route. If the previous point-of-sale provider retail consumer accepts the offer before the time limit expires, then the point-of-sale provider adds the additional order to the delivery route 614 and the initial retail consumer receives a discount for each additional order added to the delivery route 616 up to a pre-determined maximum by the point-of-sale provider, such as $1 off the original order price for each additional order up to the total cost for the original order price, as an incentive to use the Free Lunch software. With this incentive, it is possible for the initial retail consumer to receive a free pizza. Initial retail consumer can view the progress of their order and the incentives earned via the Free Lunch software installed on their device. All orders for the deviation path delivery route are then prepared for delivery 618. The point-of-sale provider then delivers the orders along the deviation path with the order for the initial retail consumer being delivered either first or last 620, but preferably first.

The point-of-sale provider may also increase their profitability by including additional products to the delivery truck for sale while deliveries along the deviation path are being made. If additional products are made available on the delivery truck, they are only available to auction subscribers with a location within the pre-determined deviation path and the point-of-service provider prepares these additional products for delivery 622. The Free Lunch software reviews the database of previous point-of-sale provider retail consumer information to find those previous retail consumers who have a location within the deviation path and are auction subscribers 624. The point-of-sale provider sends all of the orders along the deviation path and the additional products out for delivery 626. The Free Lunch software sends a message to those auction subscribers 350 with a location within the deviation path informing them on the availability of the additional products 628, their respective quantities and respective prices in real time 630. Those auction subscribers may purchase an additional product while quantities are available 632. After a specific amount of time has passed, the price for the additional products decreases by a specified amount 636. The auction subscribers may purchase an additional product at this new offer price at which point the Free Lunch software updates the quantities for the additional products 634. The price for the additional products will continue to decreases as time passes and auction subscribers will be able to purchase the products until either no more products are left or a pre-determined minimum by the point-of-sale provider has been reached. If an auction subscriber accepts an offer before the time limit expires, then the point-of-sale provider adds the additional order to the delivery route 638 and the initial retail consumer may receive a discount for each additional order added to the delivery route 639 up to a pre-determined maximum by the point-of-sale provider, such as 50 percent off the original order price, as an incentive to use the Free Lunch software. Delivery for all orders along the deviation path then completed 640 with the order for the initial retail consumer being delivered either first or last, but preferably first.

A method for increasing the profitability of a delivery from a point-of-sale provider 210 to an initial retail consumer 230, comprising: placing an initial order with a point-of-sale provider 110 by an initial retail consumer 230 providing a telephone number for the initial retail consumer; providing a point-of-sales software 220 for said point-of-sale provider with at least internet access or a database of contact information for previous point-of-sale provider consumers 240 wherein said contact information includes addresses; executing an algorithm on said software wherein said algorithm provides: (i) addresses located between a location for said point-of-sale provider 212 and a location for the initial retail consumer 232 wherein said addresses correspond with a pre-determined deviation path wherein said deviation path provides an acceptable delivery time for the initial retail consumer 230; (ii) a listing of previous point-of-sale provider consumers 240 wherein said consumers have an address corresponding with said deviation path and have provided a method of contact wherein said method includes at least a cell phone number; (iii) a directory of previous point-of-sale provider consumers wherein said consumers are auction subscribers 350, have an address corresponding with said deviation path and have provided a method of contact wherein said method includes at least a cell phone number; (iv) delivery of a message to each said previous retail consumer 240 found on said listing by said method of contact wherein said message is customized according to said consumer's order history or based on a current special and said message is valid for a specified period of time; (v) delivery of a message to each said auction subscriber 350 found on said directory by said method of contact wherein said message informs said consumer they are on said deviation path; providing a downloadable application for said consumers; enabling said auction subscribers 350 to view a catalog of at least one product available from said point-of-sale provider at an initial purchase price wherein said price will reduce by a specified value at specified intervals of time live via said application; enabling said auction subscribers 350 to purchase said product from said point-of-sale provider via said application; providing the initial retail consumer 330 with an incentive to use the application, place said order with said point-of-sale provider and accept that said delivery will be made via said deviation path; enabling the initial retail consumer 330 to view said incentive live as said delivery is in progress.

A system for increasing profitability when delivering to a retail consumer, comprising:

(a) a retail provider point-of-sales system 401 including a point-of-sales device programmed with a Free Lunch algorithm 407 and a queue for received delivery orders;

(b) a first memory 406 in the point-of-sales device with a database of retail provider consumer information, where the information includes at least an address, contact information, and order history;

(c) a transceiver 404 in the point-of-sales device configured to transmit and receive messages;

(d) a first portable communication device programmed and configured for use by an initial retail consumer 330, the first device being programmed with the Free Lunch algorithm 407;

(e) a wireless transceiver 410 in the first device configured to wirelessly transmit and receive messages from the point-of-sales device;

(f) a second portable communication device 409 programmed and configured for use by second retail consumer;

(g) a wireless transceiver 410 in the second device configured to wirelessly transmit and receive messages from the point-of-sales device.

A system for increasing profitability when delivering to a retail consumer, comprising:

(a) a retail provider point-of-sales system 401 including a point-of-sales device programmed with a Free Lunch algorithm 407 and a queue for received delivery orders;

(b) a first memory 406 in the point-of-sales device with a database of retail provider consumer information, where the information includes at least an address, contact information, and order history;

(c) a transceiver 404 in the point-of-sales device configured to transmit and receive messages;

(d) a first portable communication device programmed and configured for use by an initial retail consumer 330, the first device being programmed with the Free Lunch algorithm 407;

(e) a wireless transceiver 410 in the first device configured to wirelessly transmit and receive messages from the point-of-sales device;

(f) a second portable communication device programmed and configured for use by second retail consumer, where the second device is programmed with the Free Lunch algorithm 407, for use by a first auction subscriber;

(g) a wireless transceiver 410 in the second device configured to wirelessly transmit and receive messages from the point-of-sales device.

A system for increasing profitability when delivering to a retail consumer, comprising:

(a) a retail provider point-of-sales system including a point-of-sales device 401 programmed with a Free Lunch algorithm and a queue for received delivery orders;

(b) a first memory 406 in the point-of-sales device with a database of retail provider consumer information, where the information includes at least an address, contact information, and order history;

(c) a transceiver in the point-of-sales device 404 configured to transmit and receive messages;

(d) a first portable communication device 407 programmed and configured for use by an initial retail consumer, the first device being programmed with the Free Lunch algorithm;

(e) a wireless transceiver 408 in the first device configured to wirelessly transmit and receive messages from the point-of-sales device;

(f) a second portable communication device programmed and configured for use by second retail consumer, where the second device is programmed with the Free Lunch algorithm 407, for use by a first auction subscriber;

(g) a wireless transceiver 410 in the second device configured to wirelessly transmit and receive messages from the point-of-sales device, and where the first and second device are connected to the point-of-sales device wirelessly.

A method for increasing profitability when delivering to a retail consumer comprising:

(a) transmitting an initial retail order from a first portable communication device to a retail provider point-of-sales system wirelessly 602;

(b) receiving the initial retail order;

(c) placing the initial retail order in a queue for delivery;

(d) calculating a deviation path on the point-of-sales system via a Free Lunch algorithm between a location for the retail provider point-of-sales system and a location provided by the first portable communication device 604;

(e) analyzing a database of retail provider consumer information on the point-of-sales system for at least one previous retail provider consumer with an address on the deviation path 606;

(f) transmitting a first offer order from the retail provider point-of-sales system to a second portable communication device for use by the previous retail provider consumer wirelessly, where the first offer order is customized based on previous retail provider consumer's order history, where the order history is stored in the database 610, and if accepted;

(g) adding the first offer order to the queue for delivery 614;

(h) providing an incentive to the initial retail order for the first offer order being placed in the queue 616 and repeating steps (f) to (h) for each previous retail provider consumer with an address on the deviation path;

(i) preparing orders in the queue for delivery 618;

(j) delivering orders in the queue with delivery of the initial retail order scheduled first or last 620, but preferably first.

A method for increasing profitability when delivering to a retail consumer comprising:

(a) transmitting an initial retail order from a first portable communication device to a retail provider point-of-sales system wirelessly 610;

(b) receiving the initial retail order;

(c) placing the initial retail order in a queue for delivery;

(d) calculating a deviation path on the point-of-sales system via a Free Lunch algorithm between a location for the retail provider point-of-sales system and a location provided by the first portable communication device 606;

(e) analyzing a database of retail provider consumer information on the point-of-sales system for at least one previous retail provider consumer with an address on the deviation path 608;

(f) transmitting a first offer order from the retail provider point-of-sales system to a second portable communication device for use by the previous retail provider consumer wirelessly, where the first offer order is customized based on previous retail provider consumer's order history, where the order history is stored in the database 610, and if accepted;

(g) adding the first offer order to the queue for delivery 614;

(h) providing an incentive to the initial retail order for the first offer order being placed in the queue 616 and repeating steps (f) to (h) for each previous retail provider consumer with an address on the deviation path;

(i) preparing orders in the queue for delivery 618;

(j) delivering orders in the queue with delivery of the initial retail order scheduled first or last 626, but preferably first.
(i) preparing a plurality of additional products for purchase for purchase by a first auction subscriber during delivery 622;
(ii) analyzing the database for at least one auction subscriber with an address on the deviation path 624;
(iii) transmitting a first auction offer order from the retail provider point-of-sales system to a third portable communication device for use by the auction subscriber wirelessly, where the first auction offer order comprises the plurality of additional products prepared for delivery 628;
(iv) if the first auction offer order is rejected, decreasing the price of the plurality of additional products after a given timer has lapsed 636;
(v) if the first auction offer order is accepted, updating the quantity of additional products and adding the first auction offer order to the queue for delivery 634;
(vi) transmitting the updated information for the plurality of additional products to the third portable communication device 630, and repeating steps (i) to (vi) until the quantity of the plurality of additional products is zero or the price of the plurality of additional products has reached a pre-set minimum price.

Having described preferred embodiments of a new and improved method, it is believed that other modifications, variations and changes will be suggested to those skilled in the art in view of the teachings set forth herein. It is therefore to be understood that all such variations, modifications and changes are believed to fall within the scope of the present invention.

We claim

1) A system for increasing profitability when delivering to a retail consumer, comprising:
(a) a retail provider point-of-sales system including a point-of-sales device programmed with a Free Lunch algorithm and a queue for received delivery orders;
(b) a first memory in said point-of-sales device with a database of retail provider consumer information, wherein said information includes at least an address, contact information, and order history;
(c) a transceiver in said point-of-sales device configured to transmit and receive messages;
(d) a first portable communication device programmed and configured for use by an initial retail consumer, said first device being programmed with said Free Lunch algorithm;
(e) a wireless transceiver in said first device configured to wirelessly transmit and receive messages from said point-of-sales device;
(f) a second portable communication device programmed and configured for use by second retail consumer; and
(g) a wireless transceiver in said second device configured to wirelessly transmit and receive messages from said point-of-sales device.

2) The system of claim 1, wherein said second device is programmed with said Free Lunch algorithm, for use by a first auction subscriber.

3) The system of claim 2, wherein said first and second device are connected to said point-of-sales device wirelessly.

4) A method for increasing profitability when delivering to a retail consumer comprising:
(a) transmitting an initial retail order from a first portable communication device to a retail provider point-of-sales system wirelessly;
(b) receiving said initial retail order;
(c) placing said initial retail order in a queue for delivery;
(d) calculating a deviation path on said point-of-sales system via a Free Lunch algorithm between a location for said retail provider point-of-sales system and a location provided by said first portable communication device;
(e) analyzing a database of retail provider consumer information on said point-of-sales system for at least one previous retail provider consumer with an address on said deviation path;
(f) transmitting a first offer order from said retail provider point-of-sales system to a second portable communication device for use by said previous retail provider consumer wirelessly, wherein said first offer order is customized based on previous retail provider consumer's order history, wherein said order history is stored in said database, and if accepted;
(g) adding said first offer order to said queue for delivery;
(h) providing an incentive to said initial retail order for said first offer order being placed in said queue and repeating steps (f) to (h) for each previous retail provider consumer with an address on said deviation path; and
(i) preparing orders in said queue for delivery;
(j) delivering orders in said queue with delivery of said initial retail order scheduled first.

5) The method of claim 4, step (j) further comprising:
(i) preparing a plurality of additional products for purchase for purchase by a first auction subscriber during delivery;
(ii) analyzing said database for at least one auction subscriber with an address on said deviation path;
(iii) transmitting a first auction offer order from said retail provider point-of-sales system to a third portable communication device for use by said auction subscriber wirelessly, wherein said first auction offer order comprises said plurality of additional products prepared for delivery;
(iv) if said first auction offer order is rejected, decreasing the price of said plurality of additional products after a given timer has lapsed;
(v) if said first auction offer order is accepted, updating the quantity of additional products and adding said first auction offer order to said queue for delivery; and
(vi) transmitting the updated information for said plurality of additional products to said third portable communication device, and repeating steps (i) to (vi) until the quantity of said plurality of additional products is zero or said price of said plurality of additional products has reached a pre-set minimum price.
